(19) United States
(12) Patent Application Publication
(10) Pub. No.: US 2012/0132878 A1
(43) Pub. Date: May 31, 2012

(54) HARMONIC STABILIZER FOR PORCH AND PATIO RAILINGS

(76) Inventor: Michael A. DeCosmo, Pinellas Park, FL (US)

(21) Appl. No.: 12/954,851

(22) Filed: Nov. 27, 2010

(51) Int. Cl. F16F 15/00; E04H 17/14

(52) U.S. Cl. 256/64; 248/636

(57) ABSTRACT

In a porch or patio railing system having a plurality of vertically disposed pickets, a harmonic stabilizer for dampening forced external harmonic resonance is applied thereto. Each harmonic stabilizer includes an elongated member having a c-shape configuration formed by three wall members including a back wall and a left and right side wall all integrally attached at right angles in relation to one another. A center channel of the elongated member is defined by the three side walls and also includes an open end for providing access to the center channel. A pair of inwardly extending notches attached along outer edges of the left and right side walls provides a friction fit mating mechanism when the harmonic stabilizer is employed onto one of the plurality of vertically disposed pickets.

### BACKGROUND OF THE INVENTION

1. Field of Invention

The present invention relates to a harmonic stabilizer for use with porch and patio railings. More particularly, it relates to an elongated clip-on device for use with extruded aluminum, hollow, porch or patio railings, which reduces unwanted vibrations and noise due to resonance caused by natural and man-made forces.

2. Description of the Prior Art

Both natural and man-made forces cause vibrations of varying frequencies. Those vibrations can move through the air, through any mass or structure and even through liquids such as water (e.g., through the ocean). Everything on the planet has what is known as a “natural frequency,” or the frequency at which the system vibrates without an applied force. An applied force may occur and cause the system to vibrate at a specific frequency. If the frequency of vibration caused by the force matches the natural frequency of the system, the system will “resonate” and the amplitude will build. If the system incorporates sufficient “damping,” an effect that reduces the amplitude of vibration, the vibration may never be noticeable. But in the absence of sufficient damping, the amplitude will build, and the system will resonate.

Most people are familiar with this principal when they hear and see physical structures, such as bridge cables, resonate in a crosswind. This occurs because the vibration caused by the passing wind matches the natural frequency of the cable, causing vibration. The cables do not have sufficient damping, with the frequencies matching, resonance occurs.

A powerful real world example can be seen in the Millennium Bridge in London. On the day of the bridge's opening it had as many as 2,000 people on it at any given time. The natural swaying that occurs when people walk began to cause a sway in the bridge. The sway in the bridge caused the people on the bridge to match their stride to the sway, causing further swaying of the bridge. This interaction caused a resonance, ultimately resulting in the bridge being closed for two years for repair.

A lesser example though, in terms of force, but one that happens quite often, can be seen in porch and patio railing pickets. When the wind blows, depending on the design of the porch or patio railings and other environmental conditions, unwanted vibrations in the railing pickets, caused by resonance, emit an annoying noise, typically a low frequency hum, which is disturbing to humans and domesticated animals. This phenomenon occurs greatly in beach front condominiums, hotels and other residences where there are patios over-looking the beach or another sea-side view and where there is a propensity for greater levels of wind (e.g., from the ocean, sea or a large lake).

Attempts have been made at dampening the unwanted sound by manipulating the natural frequency of the patio railings to eliminate the occurrence of resonance. Such can be seen in inventions that fill the patio railing pickets with a substance to provide a greater density to each individual picket. The idea behind this approach is to create a greater density by filling the hollow space of the picket. When filled, a larger external force, such as a stronger wind, must be subjected upon the patio railings as a whole to make the pickets resonate and thereby emit the annoying noise. The problem with this approach is that filling hollow aluminum with foam, for example, can be time consuming and expensive. Further, doing such after installation of the railings requires drilling holes in each railing picket to fill in each one, thereby degrading the railings and adding a weak point where corrosion can begin to eat away at the railing. Yet still further, this procedure most often must be done by a highly trained and specialized technician and is not a procedure that can be done by the typical homeowner. Still even further, once the pickets are foam filled, no further internal modifications to density can be done. Therefore, if filling the pickets with foam does not alleviate the problem, more than likely, the entire railing set must be removed and thrown away, and a different approach then taken. Also, it is not practical or cost effective to pre-fill the pickets, because no one knows absolutely whether the railing system will actually resonate and cause the annoying hum until it is installed at the targeted location.

Therefore, what is needed is a different approach that does not require a time consuming and expensive procedure that degrades the railings by drilling holes, such as the foam filling method described hereinabove, and that does not require the use of a highly trained and specialized technician. What is needed is a simple and inexpensive solution that can be carried out by a regular homeowner and one that can be employed and removed with ease for cleaning and other like purposes. Further, the solution should allow for modification if the first or subsequent attempts at dampening do not alleviate the vibrations and annoying hum caused by resonance.

### SUMMARY OF THE INVENTION

I have invented an improved harmonic stabilizer for use with patio railings. My invention does not try to increase the density but instead increase the stiffness of each picket of the patio railing, which raises the natural frequency of the patio railings. The new raised natural frequency of the pickets does not match the frequency of vibration induced by the wind, therefore no resonance occurs. With no resonance, there is no annoying hum. Further, by stiffening the pickets with my invention, minute changes can be made to the device to find an exact solution to alleviate all of the unwanted noise caused by the resonating railing pickets.

In particular, my harmonic stabilizer includes an elongated c-shaped clip-on member that is typically cut to the same length of a vertical patio railing picket. However, the lengths of the picket and my stabilizer do not have to be equal. A pair of small inwardly turned notches on the open end of the elongated member allows the channel formed by its c-shape to clip-on and surround a standard patio vertical picket and thereby be held in place by a simple by sturdy friction fit. Accordingly, the novel harmonic stabilizer can be employed and removed quickly and easily and without the need of a specialized technician. This also makes removal for periodic cleaning easy. Further, since no modifications (e.g., holes) are needed in the patio railing pickets, corrosion caused by moisture will not be accelerated as with foam filling methods at the point of modification. Still further, if the first attempt at dampening does not alleviate the problem, elongated members of varying thicknesses and lengths can be tried to find the exact thickness and length that stiffens the picket well enough to completely dampen all resonance caused by the wind.

### BRIEF DESCRIPTION OF THE DRAWINGS

The detailed description of the invention, contained herein below, may be better understood when accompanied by a brief description of the drawings, wherein:

FIG. 1 is a perspective view of a harmonic stabilizer used on patio railings of the present invention;

FIG. 2 is the same perspective view of the novel harmonic stabilizer of the present invention, but shown employed (clipped-on) to a patio railing picket;

FIG. 3 is a perspective view of the novel harmonic stabilizer, partially in section; and

FIG. 4 is a cross-sectional view of the novel harmonic stabilizer along lines 4-4 of FIG. 3.

### DETAILED DESCRIPTION OF THE PREFERRED EMBODIMENT

The same numerals refer to the same elements in each of the figures included herewith and in the detailed description herein below.

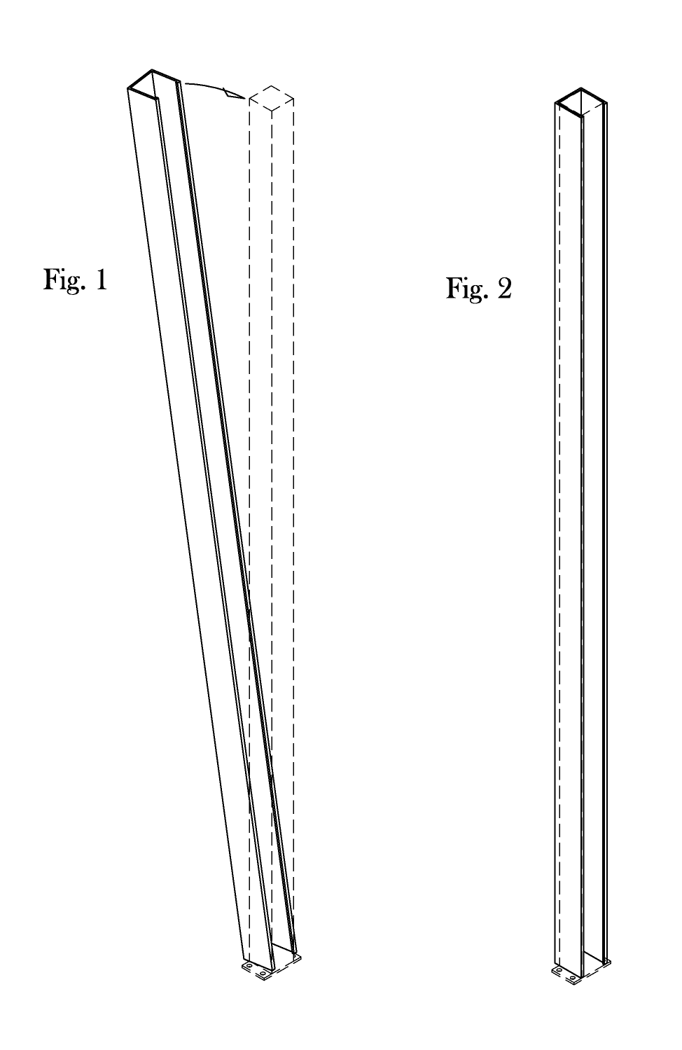

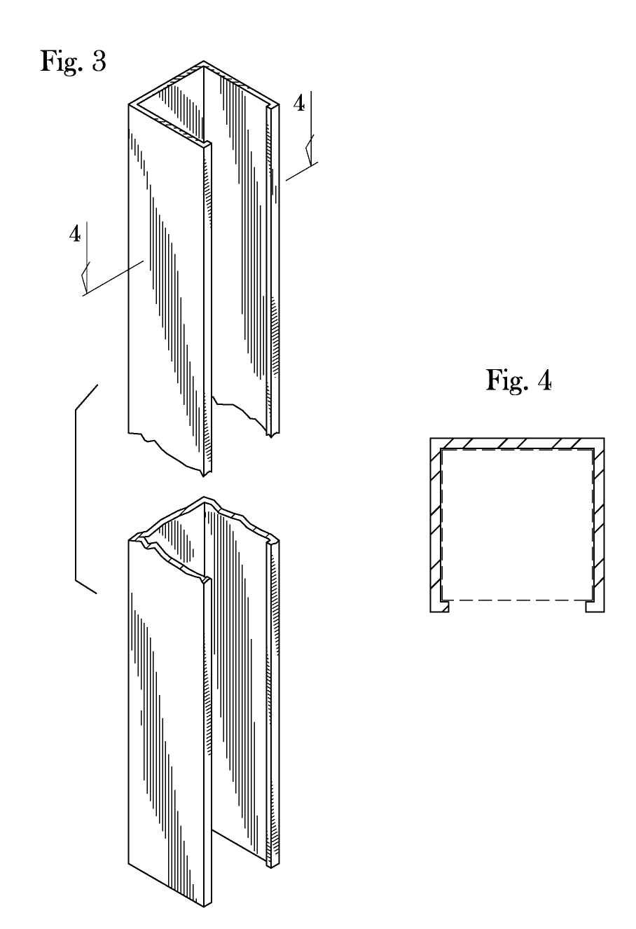

Referring to FIGS. 1-3, an elongated harmonic stabilizer 10 of the present invention, used to dampen harmonic resonance in patio railing pickets, caused by external forces, is shown. Stabilizer 10, in the preferred embodiment, is made from extruded aluminum. However, nothing herein limits the use of other readably available materials of like properties, the most important properties being stiffness and weight (i.e., being lightweight). Stabilizer 10 has a channel 12 formed by three side walls (back wall 14, left side wall 16 and right side wall 18) of which provide an open side 20. Extending inwardly, from outer edges 22 of both left and right side walls, 16 and 18, are a pair of notches 24 that are perpendicularly aligned with a vertical axis 26 of elongated harmonic stabilizer 10. Notches 26 are used to provide a tight, but removable, friction fit with a patio railing picket 28 as seen in FIGS. 1 and 2.

With continuing reference to FIGS. 1 and 2, it is shown the ease by which stabilizer 10 can be employed. In this example, stabilizer 10 is of the same general length (or more accurately, the same general height) of the patio railing picket 28. Stabilizer 10 is aligned with picket 28 at either a top or bottom end (in this example, the bottom end) and then snapped upon picket 28 thereby creating greater stiffness and effectively dampening external forced harmonic resonance.

As seen in FIGS. 1-4, stabilizer 10 has generally thin back and side walls, 14, 16 and 18, respectively. However, as noted before, the thickness of these walls can be varied by providing lesser or greater thicknesses to adequately address any external forced harmonic resonance that results in the emission of the annoying hum. Further, although FIGS. 1 and 2, show stabilizer 10 have a length equal to the length of picket 28, this is not necessary, and is only shown herein as the preferred embodiment. Accordingly, varying lengths for stabilizer 10 can be employed if doing so eliminates the resonate hum.

Equivalent elements can be substituted for the ones set forth herein, to achieve the same results in the same way and in the same manner.

Having thus described the present invention in the detailed description of the preferred embodiment, what is desired to be obtained in Letters Patent is:

1. In a porch or patio railing system having a plurality of vertically disposed pickets and at least one horizontally disposed top cross bar that intersects or connects the plurality of vertically disposed pickets, a harmonic stabilizer for dampening forced external harmonic resonance, the harmonic stabilizer comprising:
a) an elongated member having a c-shape configuration formed by three wall members;
b) the three wall members including a back wall and a left and right side wall, the three wall members integrally attached at right angles in relation to one another;
c) a center channel of the elongated member defined by the three side walls;
d) an open end providing access to the center channel; and
e) a pair of inwardly extending notches attached along outer edges of the left and right side walls for providing a friction fit mating mechanism when the harmonic stabilizer is employed onto one of the plurality of vertically disposed pickets.

2. The harmonic stabilizer for dampening forced external harmonic resonance in a porch or patio railing system having a plurality of vertically disposed pickets and at least one horizontally disposed top cross bar that intersects or connects the plurality of vertically disposed pickets of claim 1, further comprising a vertical axis of the elongated member.

3. The harmonic stabilizer for dampening forced external harmonic resonance in a porch or patio railing system having a plurality of vertically disposed pickets and at least one horizontally disposed top cross bar that intersects or connects the plurality of vertically disposed pickets of claim 2, wherein the three wall members are in axial alignment with the elongated member vertical axis.

4. The harmonic stabilizer for dampening forced external harmonic resonance in a porch or patio railing system having a plurality of vertically disposed pickets and at least one horizontally disposed top cross bar that intersects or connects the plurality of vertically disposed pickets of claim 1, wherein the harmonic stabilizer elongated member center channel snaps on and around one of the plurality of vertically disposed pickets through the elongated member open end such that a stiffness property of the picket is increased.

5. The harmonic stabilizer for dampening forced external harmonic resonance in a porch or patio railing system having a plurality of vertically disposed pickets and at least one horizontally disposed top cross bar that intersects or connects the plurality of vertically disposed pickets of claim 2, wherein the pair of inwardly extending notches attached along outer edges of the left and right side walls are perpendicularly disposed to the vertical axis of the elongated member.

6. The harmonic stabilizer for dampening forced external harmonic resonance in a porch or patio railing system having a plurality of vertically disposed pickets and at least one horizontally disposed top cross bar that intersects or connects the plurality of vertically disposed pickets of claim 1, wherein the length of the elongated member is equal to the length of one of the plurality of vertically disposed pickets to which it is employed upon.

7. The harmonic stabilizer for dampening forced external harmonic resonance in a porch or patio railing system having a plurality of vertically disposed pickets and at least one horizontally disposed top cross bar that intersects or connects the plurality of vertically disposed pickets of claim 1, wherein the length of the elongated member is less than the length of one of the plurality of vertically disposed pickets to which it is employed upon.

8. In a porch or patio railing system having a plurality of vertically disposed pickets and at least one horizontally disposed top cross bar that intersects or connects the plurality of vertically disposed pickets, a harmonic stabilizing system for dampening forced external harmonic resonance, the harmonic stabilizing system comprising:
a) a plurality of elongated members, each one having a c-shape configuration formed by three wall members;
b) the three wall members of each of the plurality of elongated members including a back wall and a left and right side wall, the three wall members integrally attached at right angles in relation to one another;
c) a center channel of each of the plurality of elongated members defined by the three side walls, respectively, of each of the plurality of elongated members;
d) an open end of each of the plurality of elongated members providing access to each center channel of each of the plurality of elongated members; and
e) a pair of inwardly extending notches attached along outer edges of the left and right side walls of each of the plurality of elongated members for providing a friction fit mating mechanism when each of the plurality of elongated members is employed onto each of the plurality of vertically disposed pickets.

9. The harmonic stabilizing system for dampening forced external harmonic resonance in a porch or patio railing system having a plurality of vertically disposed pickets and at least one horizontally disposed top cross bar that intersects or connects the plurality of vertically disposed pickets of claim 8, wherein a separate elongated member is employed onto each one of the plurality of vertically disposed pickets.

10. The harmonic stabilizing system for dampening forced external harmonic resonance in a porch or patio railing system having a plurality of vertically disposed pickets and at least one horizontally disposed top cross bar that intersects or connects the plurality of vertically disposed pickets of claim 9, wherein the lengths of each of the plurality of elongated members is equal to the length of each of the plurality of vertically disposed pickets to which each elongated member is employed.

11. The harmonic stabilizing system for dampening forced external harmonic resonance in a porch or patio railing system having a plurality of vertically disposed pickets and at least one horizontally disposed top cross bar that intersects or connects the plurality of vertically disposed pickets of claim 9, wherein the lengths of each of the plurality of elongated members is less than the length of each of the plurality of vertically disposed pickets to which each elongated member is employed.

12. A harmonically dampened porch or patio railing system comprising:
a) a plurality of vertically disposed pickets attached to a substrate;
b) at least one horizontally disposed cross bar intersecting the plurality of vertically disposed pickets at a perpendicular angle;
c) at least one elongated member removeably attached to at least one of the plurality of vertically disposed pickets; and
d) each of the at least one elongated members comprising:
i) three wall members including a back wall and a left and right side wall, the three wall members integrally attached at right angles in relation to one another and forming a c-shape for the at least one elongated member,
ii) a center channel defined by the three side walls,
iii) an open end providing access to the center channel; and
iv) a pair of inwardly extending notches attached along outer edges of the left and right side walls for providing a friction fit mating mechanism when the elongated member is employed onto one of the plurality of vertically disposed pickets by inserting the center channel around the vertically disposed picket through the open end.

13. The harmonically dampened porch or patio railing system of claim 12, wherein the number of elongated members is equal to the number of vertically disposed pickets.

14. The harmonically dampened porch or patio railing system of claim 12, wherein the length of the at least one elongated member is equal to the length of the at least one of the plurality of vertically disposed pickets.

15. The harmonically dampened porch or patio railing system of claim 12, wherein the length of the at least one elongated member is less than the length of the at least one of the plurality of vertically disposed pickets.
